(19) United States
(12) Patent Application Publication
(10) Pub. No.: US 2016/0000113 A1
(43) Pub. Date: Jan. 7, 2016

(54) HEAT RESISTANT COATINGS, CONFECTIONS COMPRISING THE COATINGS AND METHODS OF MAKING THESE

(71) Applicant: MARS, INCORPORATED, McLean, VA (US)

(72) Inventor: Sarah J. Potter, Slough (GB)

(73) Assignee: MARS, INCORPORATED, McLean, VA (US)

(21) Appl. No.: 14/769,202

(22) PCT Filed: Feb. 28, 2014
(86) PCT No.: PCT/US14/19492

§ 371 Date: Aug. 20, 2015

Related U.S. Application Data
(60) Provisional application No. 61/794,445, filed on Mar. 15, 2013.

(51) Int. Cl. A23G 3/42; A23G 3/34; A23G 3/54

(52) U.S. Cl. CPC A23G 3/42; A23G 3/54; A23G 3/0065; A23V 2002/00

(57) ABSTRACT

The present invention provides a heat resistant coating, confection comprising the coating, and methods of making these. More specifically, the heat resistant coating comprises at least one layer comprising an amount of glycerol less than 3 wt. %. In some embodiments, glycerol is the sole component of at least one layer. Because the amount of glycerol used is minimized in some layers, or the sole component of others, the processing difficulties that can be encountered when higher amounts of glycerol is mixed with other things can be avoided. And yet, the coating, and confections comprising the same may exhibit heat resistance to the same, or even better, degree, than conventional coatings or confections comprising the conventional coatings.

### FIELD

The present invention relates to heat resistant coatings, confections comprising the coating and methods of making these.

### BACKGROUND

Much of the desirable eating experience of fat-based confectionery, and chocolate confectionary in particular, is related to its ability to melt quickly and completely to provide the consumer thereof with a lubricious, indulgent eating experience. In chocolate, this ability is often directly related to the use of cocoa butter as at least a portion of the fat component in the confection. With a sharp melting point very near 37° C., cocoa butter provides the desirable melting profile upon ingestion, and thus, a large component of the desired overall consuming experience.

However, what is a desirable trait from a consumer's perspective is not necessarily a positive attribute from a manufacturing, shipping and/or handling perspective. For example, the quick and complete melting at 37° C. can become a product storage and quality concern, particularly in geographies where the environmental temperature averages at or above 37° C. These concerns may be exacerbated in regions where economic circumstances are not conducive to the wide spread use of refrigerated storage.

In an attempt to make certain fat-based confections (such as chocolate) heat resistant, confectioners have added ingredients or have attempted to alter the processing conditions of the confection. However, such additional ingredients or revised processing conditions often result in an organoleptically undesirable product or in a product that is difficult to manipulate during processing due to greatly increased or decreased viscosity.

It would thus be desirable to provide heat resistant confections that provide the desired organoleptic experience, that are yet capable of substantially maintaining their shape and/or structure prior to consumption, i.e., during shipment, storage and/or other handling. It would also be desirable to provide heat resistant confections that provide the desired organoleptic experience, yet are not difficult to process due to increased or decreased viscosity. Further advantages would be provided if the confections could be manufactured with little, or no, additional expense, whether in the form of raw materials, capital equipment, or utility costs.

### BRIEF DESCRIPTION

The present invention provides a heat resistant coating, confection comprising the coating, and methods of making these. More specifically, the heat resistant coating comprises at least one layer having minimized amount glycerol, and/or at least one layer consisting solely of glycerol. Because the amount of glycerol is minimized in layers comprising other components, the processing difficulties that can be encountered when glycerol is mixed with other things can be avoided, as can also be seen when the glycerol is applied as the sole ingredient of at least one layer. Also, negative impact on the taste profile of the other components can also be minimized or avoided. And yet, the coating, and confections comprising the same may exhibit heat resistance to the same, or even better, degree, than conventional coatings, wherein glycerol is mixed with at least one other ingredient in at least one layer, or confections comprising the conventional coatings.

In one aspect, a multilayered coating for a confection is provided. The multilayered coating comprises at least one layer of the coating comprises an amount of glycerol less than 3 wt. %, or consists solely of glycerol. The processing difficulties that can be seen when glycerol is mixed with other components in greater amounts are thus minimized, or eliminated entirely. The other components of the glycerol containing layer may be sugar syrups or confections, such as chocolate. In some embodiments, other layers of the multilayered coating may be substantially free of glycerol.

Surprisingly, the use of the lower amount of glycerol in a coating layer, or application of at least one layer consisting solely of glycerol, may provide the same, or better heat resistance to a substrate to which the coating is applied, than coatings having at least one layer comprising glycerol in conventional amounts, i.e., of greater than 7 wt. %, or greater than 5 wt. %, or greater than 3 wt. %. And so, in another aspect, a confection is provided comprising the multilayered coating applied to an edible core. Any of the layer comprising glycerol, the layer consisting solely of glycerol, or the layer not comprising glycerol may be applied directly to the edible core, and the remaining layers applied in any number or arrangement of layers comprising glycerol, not comprising glycerol, or consisting solely of glycerol. One or more of the layers may completely surround the edible core, or, one or more may be discontinuous. The edible core may comprise, e.g., chocolate, white chocolate, taffy, nougat, crème, marshmallow, caramel, nuts, nut butter, nut crème, fudge, puffed grain, fruit, gelatin, a cookie, a biscuit, a meringue, a dry aerated mass, or combinations thereof.

The use of lessor amounts of glycerol than conventional, or application of layers consisting solely of glycerol not only can provides cost savings in the form of a lessor raw material requirement, but also, can alleviate processing concerns that may otherwise be associated with application of coatings comprising higher amounts of glycerol. For example, in may confections, including chocolate, addition of glycerol can result in a dramatic viscosity increase that can, in turn, render the resulting coating, difficult if not impossible, to work with.

And so, in yet another embodiment, a method of making a heat resistant confection is provided. The method comprises applying at least one layer comprising an amount of glycerol less than 3 wt. %, and/or consisting solely of glycerol, to an edible core. Layers not comprising glycerol may also be applied, and the layer(s) may be applied in any number and any arrangement. Any of the layers may be applied via any known method, such as enrobing, spraying, dipping, brushing, tumbling or a combination of any number of these.

### DETAILED DESCRIPTION

The present specification provides certain definitions and methods to better define the present invention and to guide those of ordinary skill in the art in the practice of the present invention. Provision, or lack of the provision, of a definition for a particular term or phrase is not meant to imply any particular importance, or lack thereof. Rather, and unless otherwise noted, terms are to be understood according to conventional usage by those of ordinary skill in the relevant art.

The terms “first”, “second”, and the like, as used herein do not denote any order, quantity, or importance, but rather are used to distinguish one element from another. Also, the terms “a” and “an” do not denote a limitation of quantity, but rather denote the presence of at least one of the referenced item, and the terms “front”, “back”, “bottom”, and/or “top”, unless otherwise noted, are merely used for convenience of description, and are not limited to any one position or spatial orientation.

If ranges are disclosed, the endpoints of all ranges directed to the same component or property are inclusive and independently combinable (e.g., ranges of “up to 25 wt. %, or, more specifically, 5 wt. % to 20 wt. %,” is inclusive of the endpoints and all intermediate values of the ranges of “5 wt. % to 25 wt. %,” etc.).

Reference throughout the specification to “one embodiment” or “an embodiment” means that a particular feature, structure, or characteristic described in connection with an embodiment is included in at least one embodiment. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments. As used in this specification and the appended claims, the singular forms “a”, “an”, and “the” include plural referents unless the content clearly dictates otherwise. Thus, for example, reference to a composition containing “a compound” includes a mixture of two or more compounds. As used in this specification and the appended claims, the term “or” is generally employed in its sense including “and/or” unless the content clearly dictates otherwise.

All numeric values are herein assumed to be modified by the term “about,” whether or not explicitly indicated. The term “about” generally refers to a range of numbers that one of skill in the art would consider equivalent to the recited value (i.e., having the same function or result). In many instances, the terms “about” may include numbers that are rounded to the nearest significant figure.

Weight percent, percent by weight, % by weight, and the like are synonyms that refer to the concentration of a substance as the weight of that substance divided by the weight of the composition and multiplied by 100.

The recitation of numerical ranges by endpoints includes all numbers subsumed within that range (e.g. 1 to 5 includes 1, 1.5, 2, 2.75, 3, 3.80, 4, and 5).

As used herein, the phrase “chocolate composition” is meant to indicate a composition that includes one or both of cocoa butter and/or cocoa solids, and is not necessarily limited to any legal definition promulgated by jurisdictions in which this application may be filed and prosecuted. The term “heat resistant” means a fat based confection that retains its shape and/or can be handled without leaving a residue after exposure to elevated temperatures, temperatures of at least 30° C., or 32° C., or 34° C., or 36° C., or even 37 C or greater. Ways of measuring heat resistance can include rack testing and tactile testing. Rack testing is a method used to determine the extent to which a fat based confection retains its shape upon exposure to various temperatures and tactile testing is a method used to determine the extent to which a fact based confection can be handled without leaving a residue. The phrase “fat based confection” means any confection including at least 17, or 20, or 23, or 25, or 27 or 29, or 30 or greater percent fat, from any source. In some embodiments, a fat based confection includes cocoa solids and/or cocoa butter/cocoa butter alternative.

The present invention provides a heat resistant coating, confection comprising the same and methods of making these. The heat resistance of the coating may be conferred via inclusion of a layer comprising less than 3 wt. % of glycerol and/or consisting solely of glycerol. Other layers of the coating may not comprise glycerol at all. Heat resistance is thus conferred with lesser amounts per layer of glycerol than conventional, and in some embodiments, less overall amounts in the entire coating, and thus, cost savings are provided. Additionally, the processing difficulties that may be seen when glycerol is mixed with other components in higher amounts, e.g., sharp viscosity increases, are minimized, or eliminated entirely.

Any number of the layer comprising glycerol and/or layer consisting solely of glycerol may be applied in any order. In some embodiments, layers not comprising glycerol are also applied and may similarly be applied in any number and order with the glycerol layers. In those embodiments comprising at least one layer comprising less than 3 wt. % glycerol and/or at least one layer not comprising glycerol, the remaining components of the coating layer may be the same, or different. In some embodiments, one or more layers may be the came as the edible core, e.g., one or more chocolate layers either comprising less than 3 wt. % glycerol, or not comprising glycerol, may be applied to an edible core comprising chocolate.

The at least one layer comprising less than 3 wt. % glycerol, or consisting solely of glycerol, may make use of any food grade glycerol. Grades of glycerol are commercially available with very little water content, i.e., less than 5%, 4%, 3%, 2%, 1% or even less than 0.9%, or less than 0.8%, or less than 0.7%, or even less than 0.6%, or about 5% water or less, and these may be used in some embodiments. Glycerol can thus act as a ‘solvent’ for the sweetener in a fat based confection without introducing the detrimental effects of water. The minimization of water in the confection is desirable due to the deleterious effects water can have on the rheology and taste profile of a confection such as chocolate. The presence of even small amounts of water also introduces the potential for microbial growth in the confection.

Indeed, in some embodiments, the present coatings and/or confections desirably comprise no added water or are said to be free of or substantially free of water. That is, although some components of the confection may inherently include small amounts of water, so that the presence of small amounts of water, e.g., less than 1%, are unavoidable, the present confections do not have any water added thereto as free water. As a result, the confections have only that amount of water present in the other components utilized, e.g., a total water content of less than 1 wt. %, or less than 0.9 wt. %, or less than 0.8 wt. %, or less than 0.7 wt. %, or less than 0.6 wt. %, or less than 0.5 wt. %, or less than 0.4 wt. %, or less than 0.3 wt. %, or less than 0.2 wt. %, or in some embodiments, less than even 0.1 wt. % water.

The layers of the coating not comprising glycerol may comprise any other ingredient typically used in a coating for a food product, and especially a confection, and may include fat or sugar based coatings. Such coatings may typically include sugar syrups, chocolate, compound coatings, white chocolate or combinations of any number of these.

Such coatings may typically include a sweetener, and in the instance of the chocolate or compound coatings, a fat component, and a nonfat solids component. Whereas conventional coating or confection formulations for heat resistant confections may typically include additional ingredients that impart the heat resistance, e.g., such as gelling agents, including hydrocolloids, fibers, humectants, etc., the present coatings and confections utilize known components, albeit in reduced amounts, or as sole components of a layer of a coating. As such, the additional expense associated with the use of less conventional components, including initial cost, and potentially capital, utility and other implementation costs, is minimized or completely avoided.

Sweeteners suitable for use in sugar syrups or fat based confections include any natural sugar, i.e., suitable sweeteners include sucrose, dextrose, galactose, fructose, lactose, maltose, corn syrup solids, molasses, isomers and other derivatives of these, and combinations of any number of these. Sugar alcohols may also be used to sweeten fat based confections, and these include sorbitol, isomalt, lactitol, maltitol, mannitol, xylitol, erythritol and the like. In those embodiments wherein a sugar alcohol is desirably used to sweeten the fat based confection, polyols other than glycerol may be used. Or, the glycerol used in the glycerol layer may have a dual functionality and may act to provide the heat resistance and to provide at least a portion of the desired sweetness to the coating and/or confection.

Artificial sweeteners may also be utilized in confections of the invention and examples of these include aspartame, acesulfame-k, cyclamates, saccharin, sucralose, nechesperidin, dihydrochalone, alitame, glycyrrhizin, or combinations of these. In an embodiment, the sweetener comprises sucrose, lactose, molasses or combinations thereof. In another embodiment, the sweetener comprises sucrose, lactose or combinations thereof.

In some embodiments, a monosaccharide may be used to sweeten the layer comprising glycerol, or other layers, of the multilayer coating, and may enhance the heat resistance thereof. While not wishing to be bound by any theory, it is believed that any such monosaccharide may interact with the glycerol, in layers in which it is included, or other polyols in layers in which they are included, to form or enhance the heat resistance of the coating or confection. Monosaccharides are thought to interact more readily with glycerol, e.g., than the disaccharide bulk sweetener sucrose, and therefore more amenable or able to form a desired heat resistant structure. This interaction and the structure formed thereby are advantageously maintained over the processing of the confection, including any period at elevated temperatures, e.g., curing, shipping and/or storage periods, since glycerol does not evaporate out at temperatures typically experienced by the coating/confection during such periods.

This interaction and its effects are surprising since typically, monosaccharides have been included, if at all, in confections, in order to achieve a desired level of sweetness in a confection without detrimentally impacting the texture. That is, because of the relatively small particle size compared to conventional bulk sweeteners, e.g., sucrose, monosaccharides are not typically associated with imparting a ‘grainy’ texture to confections in which they may be used.

Indeed, conventional methods of providing heat resistance via formation of a lattice structure using bulk sweeteners, while generally inclusive of monosaccharides, are typically directed primarily at more conventionally utilized disaccharides, e.g., sucrose. Even so, such conventional methods teach that the water (or other solvent) necessarily included in order to mobilize the bulk sweeteners in the confections prepared thereby, must be removed for the bulk sweetener to form the structure thought to impart heat resistance.

Such methods, and the confections prepared thereby, thus not only include amounts of water detrimental to processing, but also, amounts of water that may invite bacterial growth during the manufacturing process. Furthermore, confections with added water may typically not provide the taste and texture desired by consumers, and as a result, these products are not typically commercially successful.

In contrast, the present coatings/confections, and methods of making the same may not include any added water, and in fact, in those embodiments wherein glycerol is used in combination with chocolate, even those amounts of water added via the inclusion thereof in the components thereof is minimized, as in some embodiments, glycerol having a purity of 99% or greater may be used. The present compositions therefore do not sacrifice taste or texture attributes, and are expected to enjoy greater commercial success than heat resistant confections with added water.

The monosaccharide optionally utilized in the glycerol or non-glycerol layer is not particularly limited, and any may be utilized. For example, suitable monosaccharides include dextrose, fructose, galactose, polymeric forms of these, anhydrous forms of these, hydrates of these, or combinations of these. In some embodiments, the monosaccharide is desirably dextrose, dextrose monohydrate, anhydrous dextrose, or combinations of these. Of these, dextrose monohydrate and anhydrous dextrose are preferred, and dextrose monohydrate is particularly preferred. While not wishing to be bound by any theory, it is believed that the molecule of water present in dextrose monohydrate, as opposed to the lack thereof in anhydrous dextrose may interact with the other bulk sweeteners in combination with the polyol (or glycerol in the case of the glycerol layer) to form or enhance the heat resistant structure of the confection.

In some embodiments, dextrose provides a further sensory benefit due to its negative heat of solution. Dextrose has a negative heat of solution of about −25.2 cal/gm and thus can impart a cooling sensation that improves the sensory experience of the confection. In some embodiments, the sensory benefit is experienced when dextrose is used in an amount of less than 8% w/w by weight of the confection while in other embodiments dextrose is used in an amount of from about 1% to about 8% w/w by weight of the confection. In still other embodiments, dextrose is used in an amount of from about 1.5% to about 4% w/w by weight of the confection.

Other materials that provide a negative heat of solution can be used instead of or in combination with dextrose to provide the sensory benefit of a cooling sensation. The materials include polyols such as sorbitol, mannitol, maltitol, xylitol, lactitol, hydrogenated isomaltulose, erythritol. In some embodiments, a cooling sensation can be provided by including a polyol with a negative heat of solution in an amount of from about 0.5% to about 15% w/w by weight of the confection. In some embodiments, the polyol with a negative heat of solution is selected from the group comprising sorbitol, mannitol, xylitol, erythritol, and combinations thereof.

A fat component may also be included in any fat based coating layers included in the coating/confection of the invention. Such a fat may be any animal or vegetable based fat, but may also be synthetic, if substantially similar to useful animal or vegetable fats. Desirably, the fat component will comprise cocoa butter, butterfat, cocoa butter replacers, cocoa butter equivalents, cocoa butter substitutes, animal fat, vegetable fat, or combinations of these.

Cocoa butter equivalents include illipe, Borneo tallow, tengkawant, palm oil, shea, kokum gurgi and mango kernel. Cocoa butter substitutes include laurics, which may typically be based upon palm kernel oil and coconut oil, and non-laurics, which may include soya, cottonseed, peanut, rapeseed and corn oil. Suitable vegetable oils include many of the non-lauric cocoa butter substitutes, i.e., corn oil, cottonseed oil, rapeseed oil, and also include palm oil, safflower and sunflower oil. In some embodiments, the fat component comprises cocoa butter.

The nonfat solids component may comprise cocoa solids, milk solids or combinations of these.

Polyols other than glycerol may be used in the non-glycerol containing layers, but their use is not required as the use of a layer consisting solely of glycerol and/or at least one layer comprising less than 3 wt. % glycerol is expected to provide the coating/confection with excellent heat resistance. Suitable polyols desirably have a boiling point greater than 105° C. so that at least some portion, desirably a majority (greater than 50%), and more desirably substantially all (e.g., greater than 75 wt. %, or 80 wt. %, or 85 wt. %, or 90 wt. %, or 95 wt. %, or even greater than 99 wt. %), of the polyol will remain within the during processing. Desirably a polyol will have a FEMA and/or GRAS designation, and may have a boiling point greater than 110° C., 120° C., 130° C., 140° C., 150° C., 160° C., 170° C., 180° C., 190° C., 200° C., 210° C., 220° C., 230° C., 240° C., 250° C., 260° C., 270° C., 280° C. or even 290° C. For example, suitable polyols include but are not limited to sorbitol, maltitol, mannitol, xylitol, isomalt, lactitol and erythritol. Combinations of these are also suitable. While isomers or derivatives, including hydrates and hydrogenates, of the polyol(s) may be used, the polyol need not be encapsulated, gelled, polymerized, or otherwise altered from its purchased state to be used in the confections provided. Rather, the chosen polyol(s) may advantageously be used ‘as is’. Emulsifiers or other surface active agents may be used, and so, in some embodiments, the non-glycerol layer comprises lecithin.

Fat based coatings/confections may further comprise an emulsifier in any or all of the glycerol layer, non-glycerol layer or edible core. Many emulsifiers are known to those of ordinary skill in the art that are suitable for use in food, and any of these may be utilized. Suitable emulsifiers include, e.g., lecithin, including soy lecithin as well as lecithin derived from other vegetable sources, such as soybean, safflower, corn, etc., fractionated lecithins enriched in phosphatidyl choline, phosphatidyl ethanolamine, phosphatidyl inositol, or combinations of these, monophosphate derivatives or diacetyl tartaric acid esters of mono- and diglycerides (sometimes referred to as PMD/DATEM), monosodium phosphate derivatives of mono- and diglycerides of edible fats or oils, sorbitan monostearate, polyoxyethylene sorbitan monostearate, hydroxylated lecithin, fractionated oat oils, lactylated fatty acid esters of glycerol and propylene glycol, polyglycerol esters of fatty acids, propylene glycol mono- and di-esters of fats and fatty acids, sucrose polystearate, ammonium phosphatide, sucrose polyerucate, polygylcerol polyricinoleate, and the like. Combinations of any number of these may also be used. Typically, such agents may be included in confections in amounts of less than 1 wt. %, or more typically, from 0.1 wt. % to 0.3 wt. %, based upon the total weight of the fat based confection.

The heat resistant coating may desirably be coated onto an edible core to provide a heat resistant confection. Examples of edible cores, or centers, useful in confections of the invention may include chocolate, white chocolate, taffy, nougat, marshmallow, crème, caramel, nuts, nut butter, nut crème, fudge, puffed grain, fruit, gelatin, cookie, biscuit, meringue, dry aerated mass, or combinations thereof. The edible core may be the same as an optional fat-based or sugar-based (non-glycerol) layer or it may be different. In an embodiment the edible core and the fat-based and/or sugar-based (non-glycerol) layer are both comprised of chocolate.

The edible core or center may be molded, formed, or deposited. If an edible core is deposited, such depositing may be accomplished via a chip depositor, a removable depositor, a point depositor, a one-shot depositor, a ribbon depositor, a drop depositor, a cluster depositor, or any combination thereof. Molding of the core may be desirable if the core composition is fluid at heightened temperatures but solid at about ambient temperature. For example, if the center is chocolate, the chocolate may be provided in a molten state, poured into a mold, cooled, and removed from the mold to provide a specific shape about which other layers are coated. Forming may be accomplished by any means known in the art such as rotary forming, drop rolling, wire cutting, sheeting, slitting, and combinations thereof. Confections of the invention may include a core that is fluid at greater than 27° C. and solid at ambient temperature.

A process for making a heat-resistant confection is also provided. The process includes providing an edible core and coating the core with a multilayered heat resistant coating, wherein at least one layer of the coating comprises less than 3 wt. % glycerol, or, consists solely of glycerol. The coating step may be repeated any number of times, using the coating comprising glycerol and/or the glycerol only, and any number of fat or sugar based layers not comprising glycerol. The edible core may be directly deposited into a manufacturing sequence, and in such embodiments, such depositing may be accomplished via a chip depositor, a removable depositor, a point depositor, a one-shot depositor, a ribbon depositor, a drop depositor, a cluster depositor, or any combination thereof.

Any of the glycerol containing layer, the non-glycerol containing layer, or the layer consisting solely of glycerol may be applied directly to the edible core. The layer comprising glycerol, as well as the optional layer not comprising glycerol, may otherwise comprise a Whatever the material, the layers may be used in any number, and any arrangement, so long as at least one layer comprises an amount less than 3 wt. % glycerol, or, consists solely of glycerol.

The layers of the coating may be applied via spraying, tumbling, enrobing, brushing, dipping, or any combination thereof, in a manner so as to substantially surround an edible core, or may be applied so as to be discontinuous about the edible core. Confections of the invention may include layers having the same composition yet the weight and/or thickness of the similarly composed layers may vary.

A layer consisting solely of glycerol, or comprising less than 3 wt. % glycerol may be provided as the outermost layer in confections of the invention. In other embodiments a fat-based and/or sugar-based (non-glycerol) layer may be provided as the outermost layer.

While not wishing to be bound by any theory, it is believed that, when so included with fat, such as when chocolate is included in the glycerol layer, glycerol may interact with and/or may assist with the dispersion of the fat within the confection. Whatever the mechanism, it has been discovered that utilizing the glycerol layer provides a more heat resistant confection, or a confection with similar heat resistance, but improved organoleptic properties, than confections comprising the same or similar ingredients that were not so prepared.

Because glycerol is used in an amount less than conventionally employed to impart heat resistance, e.g., less than 7 wt. %, or less than 6 wt. %, or less than 5 wt. %, or less than 4 wt. %, or even 3 wt. %, or less, the negative rheological effects of the addition of the same to other components of a coating are minimized, or eliminated completely and layers comprising the glycerol at 3 wt. % or less may be readily and easily applied using standard equipment. Similarly, any layer(s) consisting solely of glycerol are readily and easily applied with readily available equipment.

This is in contrast with other methods of forming heat resistant coatings/confections that may require the use of finely milled sweeteners, e.g., to a particle size on the order of nanometers, apparently under the assumption that such a small particle size will assist in the formation of a sugar lattice within the confection that will then impart some level of heat resistance. Not only can such milling equipment be expensive from a capital cost perspective, but it can also take up valuable manufacturing space and time. In contrast, including glycerol to a glycerol layer does not require the purchase of additional equipment, and/or allocation of time and space resources.

In embodiments of the invention, the benefit of enhanced heat resistance can be seen without requiring the use of additional equipment not conventionally used in confectionary manufacture to pretreat any conventional components, i.e., milling equipment to reduce the particle size of conventional components, or microwave ovens.

### EXAMPLE 1

Confections including chocolate were prepared for the following examples

| Component | % by weight |
|---|---|
| Sugar | 54.63 |
| Skim milk powder | 17.26 |
| Cocoa Liquor | 13.80 |
| Lactose | 5.82 |
| Water | 8.49 |

TABLE 2
Glycerol Chocolate Composition

| Component | % by weight |
|---|---|
| Glycerol Crumb | 77.33 |
| Cocoa Butter | 16.1 |
| Anhydrous milk fat | 5.92 |
| Lecithin | 0.65 |

A batch of crumb was produced having the composition provided in Table 1 and additionally adding 2% glycerol to the composition. Chocolate was prepared using the glycerol crumb according to the composition provided in Table 2. The glycerol chocolate was nearly lump-free and of acceptable particle size after less than 16 hours conch time.

Solid (standard) chocolate having the composition provided in Table 3 below was liquefied.

TABLE 3

| Component | % by weight |
|---|---|
| Sugar | 47.25 |
| Skim milk powder | 14.34 |
| Cocoa Liquor | 11.76 |
| Lactose | 2.73 |
| Whey | 2.06 |
| Cocoa butter | 15.36 |
| Anhydrous milk fat | 5.84 |
| Lecithin | 0.67 |

Malted milk balls (a type of dry aerated mass) were provided as the edible core and were coated with chocolate according to the following ingredients and processes:

TABLE 4

| Sample | | | Theoretical | Actual |
|---|---|---|---|---|
| # | Chocolate Type | Layers | Glycerol | Glycerol |
| 1 | Standard | Core/Non-glycerol | 0 | 0 |
| | | layer | | |
| 2 | Standard with | Core/Glycerol layer | 1.1 | 1.01 |
| | glycerol spray | | | |
| 3 | Standard/ | Core/Glycerol layer | 0.59 | 0.56 |
| | glycerol blend | | | |
| 4 | Standard with | Core/Non-glycerol | 0.28 | 0.16 |
| | glycerol top | layer/Glycerol layer | | 0.20 |
| | coat | | | |
| 5 | Glycerol | Core/Glycerol layer | 1.2 | 0.84 |

Sample 1 was provided as a control. Standard (liquefied) chocolate was used to coat malted milk ball cores. The chocolate was sprayed onto Sample 1 cores. Sample 1 included an edible core coated with a non-glycerol layer.

Sample 2 was prepared by adding 1.5% pure glycerol of the total chocolate weight to standard chocolate. The glycerol/chocolate mixture of Sample 2 was mixed in a static mixer before spraying onto the malted milk ball cores. The combined glycerol/chocolate mixture exhibited an increased viscosity but this did not inhibit coating the cores. Sample 2 included an edible core coated with a glycerol layer.

Sample 3 included preparing a mixture of 50% standard chocolate with 50% Glycerol chocolate prepared from the 2% glycerol crumb. The glycerol content of the finished chocolate should be about 0.75%. Sample 3 was therefore a reduced glycerol chocolate and was used to coat (via spray coating) the cores. Sample 3 included an edible core coated with a reduced content glycerol layer

Sample 4 included a layer of standard chocolate (non-glycerol layer) coated on the core followed by a top coat of the Glycerol chocolate prepared from the 2% glycerol crumb (glycerol layer). Sample 4 included an edible core coated with a non-glycerol layer coated with a glycerol layer.

Sample 5 included spraying edible cores with the Glycerol chocolate prepared from the 2% glycerol crumb (glycerol layer). Sample 5 included an edible core coated with a glycerol layer.

Sensory tests were run on the five samples. Sensory results provided that any sensory differences between standard and glycerol-containing chocolate were de minimus once coated onto the malted milk ball centers.

Overall glycerol content (of the sample total weight) was measured on the resultant samples and was found to be lower overall than theoretically expected. The results may be explained because the supply tanks and pipework between samples was difficult to empty and some chocolate may have been left in the system and mixed with the chocolate batches used to prepare the samples.

### Melt Resistance Testing

Melt resistance was measured by supporting 10 sweets individually on a rack and then heating to 35° C. for one hour followed by vibration for one minute. The amount of chocolate that dropped off the 10 sweets was measured in grams. A reading of 0 indicates full melt resistance as compared to a reading of 5 or above indicates little or no melt resistance. Results are provided in Table 5 below:

| Sample | | Melt resistance after | Melt resistance after |
|---|---|---|---|
| Number | Layers | 1 week | 4 weeks |
| 1 | Core/Non-glycerol | >7 | 5.43 |
| | layer | | |
| 2 | Core/Glycerol | 0 | 0 |
| | layer | | |
| 3 | Core/Reduced | 10.98 | 4.21 |
| | Glycerol layer | | |
| 4 | Core/Non-glycerol | 0 | 0 |
| | layer/Glycerol | | |
| | layer | | |
| 5 | Core/Glycerol | 0 | 0 |
| | layer | | |

Sample 3 provided no melt resistance. It is thought that the glycerol content present in the glycerol layer was too low to provide any resistance.

### EXAMPLE 2

Samples are prepared using the dry aerated mass edible cores used to prepare Samples 1-5. The liquefied Standard Chocolate provided in Table 3 is then used to coat the edible cores via spray coating for Samples 6 and 7. The Glycerol Layer for Samples 6-10 is 100% glycerol and is added via spray coating (except when Glycerol Chocolate is listed). The Glycerol Chocolate composition referenced in Samples 9 and 10 is that provided in Table 2 above. Samples 6-10 are coated with lavers according to Table 5 provided below:

| Sample # | Layers |
|---|---|
| 6 | Core/Standard |
| | Chocolate/Glycerol layer |
| 7 | Core/Standard |
| | Chocolate/Standard |
| | Chocolate/Glycerol layer |
| 8 | Core/Standard |
| | Chocolate/Glycerol |
| | layer/Standard Chocolate |
| 9 | Core/Glycerol |
| | Chocolate/Glycerol |
| | Layer/Glycerol Chocolate |
| 10 | Core/Standard |
| | Chocolate/Glycerol |
| | Layer/Glycerol Chocolate |

It is expected that Samples 6-10 prepared using a layer consisting of 100% glycerol for the glycerol layer will exhibit acceptable heat resistance.

This Example is demonstrative of the layering possible with the present invention. Samples are prepared using the dry aerated mass edible cores used to prepare Samples 1-10, chocolate cores, peanut, and marshmallows. The liquefied Standard Chocolate provided in Table 3 is used to coat the edible cores via spray coating. The Glycerol Layer for the below Samples is 100% glycerol and is added via spray coating (except when Glycerol Chocolate is listed). The Glycerol Chocolate composition referenced in the Samples below is that provided in Table 2 above. Samples may include the layering and cores provided below:

| Sample # | Layers |
|---|---|
| 11 | Aerated Core/Glycerol Chocolate/Standard |
| | Chocolate/Glycerol layer |
| 12 | Peanut Core/Standard Chocolate/Standard |
| | Chocolate/Glycerol layer |
| 13 | Marshmallow Core/Standard |
| | Chocolate/Glycerol layer/Standard Chocolate |
| 14 | Peanut Core/Glycerol Chocolate/Glycerol |
| | Layer/Glycerol Chocolate |
| 15 | Marshmallow Core/Standard |
| | Chocolate/Glycerol Layer/Glycerol |
| | Chocolate |
| 16 | Peanut Core/Standard Chocolate/Glycerol |
| | Layer/Standard Chocolate/Glycerol Layer |

1. A multilayered coating for a confection, wherein at least one layer of the coating comprises an amount of glycerol less than 3 wt. %, or, consists solely of glycerol

2. The multilayered coating of claim 1, wherein at least one other layer of the coating consists solely of glycerol.

3. The multilayered coating of claim 1, wherein at glycerol layer further comprises a confection and the confection comprises chocolate.

4. (canceled)

5. The multilayered coating of claim 1, wherein at least one layer of the multilayered coating does not comprise glycerol.

6. The multilayered coating of claim 1, wherein the layer consisting solely of glycerol is provided between the at least one other layer(s).

7. A confection comprising the multilayered coating of claim 1.

8. A confection comprising a multilayered coating and an edible core, at least one layer of the coating comprises an amount of glycerol less than 3 wt. %, or consists solely of glycerol.

9. The confection of claim 8, wherein at least one other layer of the coating consists solely of glycerol.

10. The confection of claim 8, wherein the layer comprising glycerol further comprises a confection and the confection comprises chocolate.

11. (canceled)

12. The confection of claim 8, wherein at least one layer of the multilayered coating does not comprise glycerol.

13. The confection of claim 8, wherein the layer comprising glycerol, the layer not comprising glycerol, or the layer consisting of glycerol is applied directly to the edible core.

14. The confection of claim 8, wherein at least one of any layer completely surrounds the edible core.

15. The confection of claim 8, wherein at least one of any layer is discontinuous.

16. The confection of claim 10, wherein the edible core and at least one of the layers comprising or not comprising glycerol are the same.

17. (canceled)

20. A method of making a heat resistant coated confection comprising applying at least one layer comprising an amount of glycerol less than 3 wt. %, or consisting solely of glycerol, to an edible core.

21. The method of claim 20, wherein the glycerol layer(s) is/are applied by enrobing, spraying, dipping, brushing, tumbling or a combination of any number of these.

22. The method of claim 20, wherein at least one layer of the coating does not comprise glycerol.

23. The method of claim 20, wherein the at least one layer of the coating consists solely of glycerol.

24. The method of claim 20, wherein the layer comprising glycerol, the layer not comprising glycerol, or the layer consisting solely of glycerol is applied directly to the edible core.
